(19) United States
(12) Patent Application Publication
(10) Pub. No.: US 2025/0327716 A1
(43) Pub. Date: Oct. 23, 2025

(54) FORCE SENSOR

(71) Applicant: Hyve Dynamics Holdings Limited, London (GB)

(72) Inventor: Juan Sebastian Tobon Conde, Leicester (GB)

(21) Appl. No.: 19/180,611

(22) Filed: Apr. 16, 2025

(30) Foreign Application Priority Data
Apr. 17, 2024 (GB) 2405409.0

(51) Int. Cl. G01M 9/06; G01L 1/22

(52) U.S. Cl. CPC G01M 9/06; G01L 1/2287

(57) ABSTRACT

A force sensor 10 for measuring fluid flow shear forces is provided. The sensor 10 comprises an elastomeric membrane 12, a slot 16 extending through the thickness of the elastomeric membrane 12, and a strain gauge 14, wherein the strain gauge 14 includes a first end 14A attached to a first surface 12A of the elastomeric membrane 12, a second end 14B attached to a second surface 12B of the elastomeric membrane 12 and an intermediate section 14C disposed and extending through the slot 16 in the elastomeric membrane 12. The application of shear force deforms the elastomeric membrane 12 and causes the intermediate section 14C to change in length.

### CROSS REFERENCE TO RELATED APPLICATIONS

This application claims the benefit of priority from British patent application 2405409.0, filed on 17 Apr. 2024; the entirety of which is hereby incorporated by reference herein.

### BACKGROUND OF THE INVENTION

### Field of the Invention

The present invention relates to a force sensor, particularly but not exclusively for measuring fluid flow shear forces

### Background

Understanding of fluid dynamic forces is paramount in automotive and aerospace industries, as well as in marine engineering where it contributes to the design of hydrodynamic vessels. It also serves an essential role in industrial fluid applications for monitoring and improving flow processes, fluid handling and manufacturing operations such as extrusion, in environmental monitoring where fluid dynamics play a part in ecosystem assessments, in the building and construction industry for structural fluid interaction studies, in analysing aerodynamic performance of wind turbine blades and in biomedical applications such as tissue engineering where tissue development may depend on local shear stress.

The viscosity of the fluid tends to create a shear drag due to the sliding force of the fluid particles over a surface. Shear force is mainly caused by the viscosity of the fluid (stickiness or resistance to fluid flow) and the surface's roughness (friction coefficient). Wall bounded conditions are of particular interest due to the influence of the boundary layer that is formed between the fluid in motion and the surface in contact with that fluid.

Various types of sensors can be used to measure fluid flow shear forces. These include capacitance and electric potential types of sensors. However, the readings of these types of sensors can be affected by various factors. For example, capacitance-type sensors are sensitive to external magnetic fields which can alter their readings. Therefore, these sensors need to be carefully assembled to prevent this from happening.

Electrical potential-type sensors include electrostrictive, ferroelectric and/or piezoelectric sensors. Their readings can be affected if an interference factor alters their polarisation direction due to shear force. Furthermore, other sensors include bumps and an additional frictional layer which may act as a turbulent generator and disrupt the formation of the boundary layer.

It is therefore an object of the present invention to reduce or substantially obviate the aforementioned problems.

### SUMMARY OF THE INVENTION

According to an aspect of the present invention, there is provided a force sensor for measuring fluid flow shear forces, the sensor comprising:
an elastomeric membrane having a first surface and a second surface;
a slot extending through the thickness of the elastomeric membrane from the first surface through to the second surface of the elastomeric membrane; and
a strain gauge having a first end, a second end and an intermediate section between the first end and the second end, the first end being attached to the first surface of the elastomeric membrane, the second end being attached to the second surface of the elastomeric membrane and the intermediate section extending through the slot, the intermediate section being configured to change in length on application of shear force which deforms the elastomeric membrane.

Advantageously, the present invention is not affected by interference factors (such as change in external magnetic field or change in polarisation) which could potentially affect its readings.

The sensor may be configured to be fixed to a host substrate, material or surface.

In some embodiments, the second surface of the elastomeric membrane and/or the second end of the strain gauge may be configured to be fixed to the host substrate, material or surface.

In some embodiments, the sensor may be configured to be disposed, sandwiched or embedded in the host substrate or material. For example, the sensor may be embedded within a composite material.

Either arrangement above provides an in-plane stretchable shear bidirectional force sensor which can measure fluid flow shear forces i.e. the shear force caused by flow of a viscous fluid against the first surface of the elastomeric membrane or against a specific shape, for example a car or aircraft part.

The intermediate section of the strain gauge is disposed through the thickness of the elastomeric membrane, and is stretched or compressed when the first surface moves with respect to the second surface, for example, when the membrane is stretched or compressed due to shear force. The application of the fluid flow shear force to the first surface of the elastomeric membrane or to the material embedded with the sensor causes stretch or deformation of the elastomeric membrane which then causes deformation of the strain gauge i.e. change in length of the intermediate section.

The deformation of the intermediate section is proportional to the alteration in electrical resistance of the strain gauge. This change in electrical resistance of the strain gauge is then used as an indicator of the extent of the in-plane strain or shear strain experienced by the elastomeric membrane due to the shear of the viscous fluid against the first surface of the elastomeric membrane.

The sensor is a bidirectional sensor, meaning that it can measure the deformation or strain of the elastomeric membrane in two directions, for example, in opposite directions to each other.

The slot is a cut in the elastomeric membrane. The slot allows for the configuration of the strain gauge where its first end can be attached to the first surface of the elastomeric membrane and its second end can be attached to the second surface of the elastomeric membrane.

The slot also allows the measurement zone i.e., the intermediate section of the strain gauge to be isolated. This provides a high-fidelity spatial representation of the shear force being applied.

In some embodiments, a plurality of strain gauges may be provided.

A plurality of slots may be provided in the elastomeric membrane.

The slots may be strategically arranged around the membrane, enabling the placement of sensors in a systematic way. This layout facilitates the collection of spatial shear stress data, offering a comprehensive overview of stress distribution across the surface.

When a plurality of strain gauges is provided, the intermediate section of each strain gauge may extend through a corresponding slot.

The plurality of strain gauges may be spaced apart on the elastomeric membrane.

The plurality of strain gauges may be provided within the vicinity of each other in the same configuration to detect shear force at multiple points.

Strain gauges may be arranged orthogonally to each other. This allows the overall direction and/or magnitude of the shear force to be determined, regardless of the planar direction of fluid flow. Accounting for the contribution of each strain gauge permits the calculation of the overall magnitude and direction of shear strain due to fluid flow over the surface.

In other words, by positioning the strain gauges orthogonally to one another, according to a predetermined coordinate system, it becomes possible to acquire detailed information from various orientations. This arrangement ensures a multidimensional perspective on shear stress, enhancing the accuracy and depth of the data gathered.

In embodiments where only one strain gauge is provided to the sensor, the slot may be disposed substantially at a central portion of the elastomeric membrane. This allows the strain gauge to be attached or embedded substantially at the centre of the elastomeric membrane.

The slot may extend through the thickness of the elastomeric membrane in a direction substantially perpendicular to the first and second surfaces of the elastomeric membrane.

The strain gauge may be an in-plane or shear strain sensitive semiconductor or may be made from an in-plane or shear strain sensitive semiconductive material.

The sensitivity of the strain gauge to deformation may be varied by signal amplification.

The strain gauge may comprise a metallic element and an insulating backing surrounding the metallic element.

The deformation i.e. change in length of the metallic element itself alters the electrical resistance of the strain gauge and allows the shear strain of the elastomeric membrane to be determined.

The insulating backing of the strain gauge allows the strain gauge to be easily attached to or on the elastomeric membrane, and the host substrate, material or surface.

The metallic portion may be made from copper-nickel alloy.

The insulating backing may be made from polyimide.

The metallic portion may be arranged in a zig-zag pattern of parallel lines.

The strain gauge may have a dimension ranging between 1 mm by 1 mm to 4 mm by 4 mm.

The strain gauge may have a smaller thickness than the elastomeric membrane. This allows the strain gauge to be easily attached or embedded to the elastomeric membrane.

The elastomeric membrane may have a thickness of between 0.1 mm to 0.5 mm.

The strain gauge may have a thickness of between 0.01 mm to 0.1 mm.

The slot may have a width which is substantially larger than the thickness of the strain gauge. This allows the strain gauge to be easily extended or inserted through the slot.

The elastomeric membrane may have an elastic modulus of 0.1 MPa to 3 MPa. This allows the elastomeric membrane to be very flexible and allows it to easily deform due to fluid flow.

The elastomeric membrane may be made from a semi-incompressible material or may have a Poisson's ratio close to 0.5 (+/−0.05) i.e., the elastomeric membrane may exhibit elastomeric behaviour.

The elastomeric membrane may be made from silicone or rubber.

### BRIEF DESCRIPTION OF SEVERAL VIEWS OF THE DRAWINGS

For a better understanding of the present invention, and to show more clearly how it may be carried into effect, reference will now be made by way of example only to the accompanying drawings, in which:

FIG. 1 shows a perspective view of component parts of a first embodiment of an in-plane stretchable shear bidirectional force sensor according to the present invention before a strain gauge is attached to an elastomeric membrane of the sensor;

FIG. 2 shows a side view of the elastomeric membrane of FIG. 1;

FIG. 3 shows a perspective view of a second embodiment of the in-plane stretchable shear bidirectional force sensor of the present invention when fully assembled with the strain gauge attached to the elastomeric membrane;

FIG. 4 shows a side view of the sensor of FIG. 3;

FIG. 5 shows a schematic side view of the sensor of FIGS. 3 to 4 prior to being subjected to fluid flow over a first surface of the elastomeric membrane;

FIG. 6 shows a schematic side view of the deformation of the sensor of FIG. 5 due to fluid flow in one direction; and

FIG. 7 shows a schematic side view of the deformation of the sensor of FIG. 5 due to fluid flow in the opposite direction.

### DETAILED DESCRIPTION OF THE ILLUSTRATED EMBODIMENTS

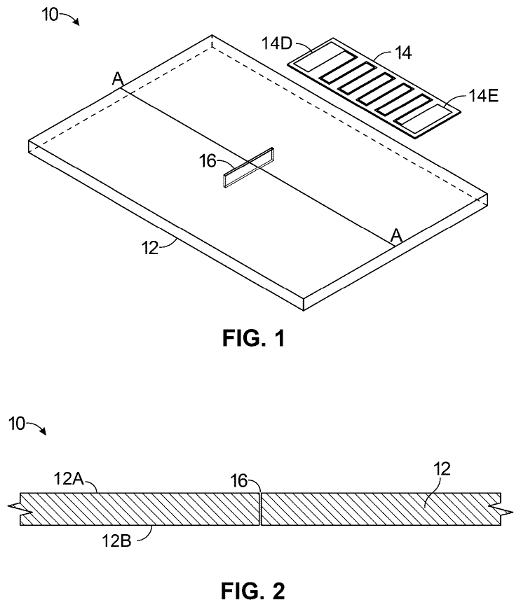

Referring firstly to FIGS. 1 and 2, an in-plane stretchable shear bidirectional force sensor for measuring fluid flow shear forces is generally indicated at 10. In FIG. 1, the sensor has not been assembled, and so the component parts are pictured separately.

The sensor 10 comprises an elastomeric membrane 12 and a strain gauge 14. In the embodiments shown, the elastomeric membrane 12 and the strain gauge 14 are both provided as rectangular sheets, but the strain gauge 14 has a smaller overall dimension and thickness than the elastomeric membrane 12.

The dimension of the strain gauge 14 can range between 1 mm by 1 mm to 4 mm by 4 mm. The thickness of the elastomeric membrane can be between 0.1 mm to 0.5 mm. The thickness of the strain gauge can be between 0.01 mm to 0.1 mm.

The elastomeric membrane 12 is a flexible semi-incompressible material (i.e., has or close to having a Poisson's ratio of 0.5) with a low shear modulus of 0.033 MPa to 0.1 MPa. This allows the elastomeric membrane 12 to stretch or compress when shear force due to fluid flow 20 is applied. The elastomeric membrane 12 can be made from rubber or silicone, for example.

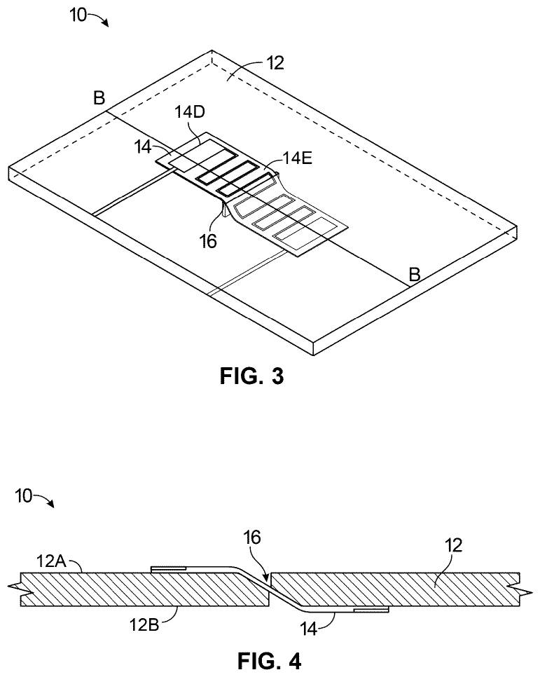

FIG. 1 shows the sensor 10 before the strain gauge 14 is attached to the elastomeric membrane 12 and FIG. 3 shows the sensor 10 when the strain gauge 14 has been attached to the elastomeric membrane 12.

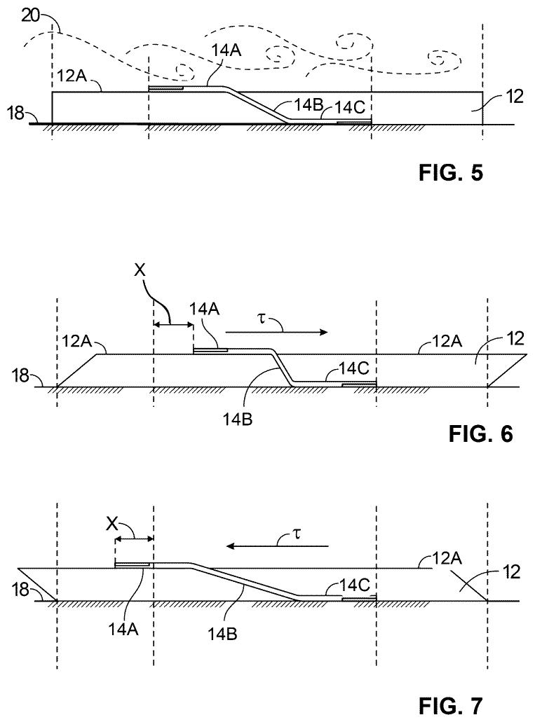

In the embodiments shown in FIGS. 1 to 7, one strain gauge is provided. A slot or a cut 16 is provided at a centre or central portion of the elastomeric membrane 12. However, in some embodiments, a plurality of slots and a plurality of strain gauges can be provided, wherein each strain gauge extends through a corresponding slot 16 in the elastomeric membrane 12. Multiple strain gauges can be used to measure the shear force at different points on a surface. Also, two strain gauges close together but arranged in orthogonal directions can be used to measure the magnitude and direction of a shear force in any direction across the surface.

The slot 16 extends through the thickness of the elastomeric membrane 12 i.e. from a first surface 12A through to a second surface 12B of the elastomeric membrane 12.

In the first embodiment (see FIGS. 1 and 2), the slot 16 extends in a direction parallel to the thickness or width of the elastomeric membrane 12 i.e. perpendicular to the length of the elastomeric membrane 12. In the second embodiment (see FIGS. 3 to 7), the slot 16 extends at an acute angle to the thickness or width of the elastomeric membrane 12.

The strain gauge 14 includes a first end 14A, a second end 14B and an intermediate section 14C located between the first end 14A and the second end 14B. The first end 14A of the strain gauge 14 is attached or fixed to the first surface 12A of the elastomeric membrane 12 and the second end 14B of the strain gauge 14 is attached or fixed to the second surface 12B of the elastomeric membrane 12.

The intermediate section 14C of the strain gauge 14 is disposed and extends through the slot 16 and forms the measurement zone of the sensor 10. The intermediate section 14C of the strain gauge 14 is not attached or fixed to any surface of the elastomeric membrane 12. This allows the intermediate section 14C to change length in unison with the deformation of the elastomeric membrane 12 when shear force is applied to the first surface 12A of the elastomeric membrane 12.

The strain gauge 14 comprises a metallic element 14D made from copper-nickel alloy and arranged in a zig-zag pattern of parallel lines, which is surrounded by an insulating backing 14E made from polyimide. The strain gauge 14 can be an in-plane sensitive semi-conductor sensor.

In use, the second surface 12B of the elastomeric membrane 12 and the second end of the strain gauge 14 is fixed to a host substrate, material or surface 18. The host substrate, material or surface 18 is the surface on which the effect of fluid flow 20 or shear force created by the fluid flow 20 is being measured by the sensor 10.

When shear force is applied to the first surface 12A of the elastomeric membrane 12, the elastomeric membrane 12 deforms, and the intermediate section of the strain gauge 14 changes length at the same time. The deformation i.e., the change in length of the metallic element 14D in the intermediate section 14C of the strain gauge 14 alters the electrical resistance of the strain gauge 14, which indicates the extent of in-plane strain or shear strain experienced by the elastomeric membrane 12 from the first surface 12A.

Depending on the direction of fluid flow 20, the intermediate section 14C of the strain gauge 14 can increase in length as shown in FIG. 6 wherein the fluid flow 20 moves in a direction towards the second end 14B of the strain gauge 14 or decrease in length as shown in FIG. 7 wherein the fluid flow 20 moves in a direction towards the first end 14A of the strain gauge 14.

In embodiments provided with a plurality of strain gauges 14, the strain gauges 14 can be provided in the same configuration, for example, parallel to each other. This allows shear force to be measured or detected in multiple places.

In embodiments provided with a plurality of strain gauges 14, the strain gauges 14 can also be provided and arranged orthogonally to each other in order to determine the overall direction and/or magnitude of the shear force, regardless of the planar direction of the fluid flow 20.

The sensor 10 can be combined with a pressure sensor disclosed in the granted patent GB2580928B, in order to couple pressure information. Shear and pressure forces are required to calculate all the axial and normal forces on a surface submerge in a fluid.

The embodiments described above are provided by way of example only, and various changes and modifications will be apparent to persons skilled in the art without departing from the scope of the present invention as defined by the appended claims.

What is claimed is:

1. A force sensor for measuring fluid flow shear forces, the sensor comprising:
an elastomeric membrane having a first surface and a second surface;
a slot extending through the thickness of the elastomeric membrane from the first surface through to the second surface of the elastomeric membrane; and
a strain gauge having a first end, a second end and an intermediate section between the first end and the second end, the first end being attached to the first surface of the elastomeric membrane, the second end being attached to the bottom surface of the elastomeric membrane and the intermediate section being disposed and extending through the slot, the intermediate section being configured to change in length on application of shear force which deforms the elastomeric membrane.

2. The force sensor as claimed in claim 1, in which the second surface of the elastomeric membrane and/or the second end of the strain gauge is configured to be fixed to a host substrate, material or surface.

3. The force sensor as claimed in claim 1, in which the sensor is configured to be disposed, sandwiched or embedded in the host substrate or material.

4. The force sensor as claimed in claim 1, in which the strain gauge is an in-plane or shear strain sensitive semiconductor or is made from an in-plane or shear strain sensitive semiconductive material.

5. The force sensor as claimed in claim 1, in which the strain gauge compromises a metallic element and an insulating backing surrounding the metallic element.

6. The force sensor as claimed in claim 5, in which the metallic element is made from copper-nickel alloy.

7. The force sensor as claimed in claim 5, in which the insulating backing is made from polyimide.

8. The force sensor as claimed in claim 1, in which the strain gauge has a dimension ranging between 1 mm by 1 mm to 4 mm by 4 mm.

9. The force sensor as claimed in claim 1, in which the strain gauge has a smaller thickness than the elastomeric membrane.

10. The force sensor as claimed in claim 1, in which the elastomeric membrane has a thickness of 0.1 mm to 0.5 mm.

11. The force sensor as claimed in claim 1, in which the strain gauge has a thickness of 0.01 mm to 0.1 mm.

12. The force sensor as claimed in claim 1, in which the slot extends through the thickness of the elastomeric membrane in a direction substantially perpendicular to the length of the elastomeric membrane.

13. The force sensor as claimed in claim 1, in which the slot has a width larger than the thickness of the strain gauge.

14. The force sensor as claimed in claim 1, in which the elastomeric membrane has an elastic modulus of 0.1 MPa to 3 MPa.

15. The force sensor as claimed in claim 1, in which the elastomeric membrane has a shear modulus of 0.033 MPa to 0.1 MPa.

16. The force sensor as claimed in claim 1, in which the elastomeric membrane is made from a semi-incompressible material.

17. The force sensor as claimed in claim 1, in which the elastomeric membrane is made from silicone or rubber.

18. The force sensor as claimed in claim 1, in which a plurality of slots and a plurality of strain gauges are provided.

19. The force sensor as claimed in claim 18, in which the plurality of strain gauges is arranged in the same configuration as each other or are parallel to each other.

20. The force sensor as claimed in claim 18, in which the plurality of strain gauges is arranged orthogonally to each other.
